(19) United States
(12) Patent Application Publication
(10) Pub. No.: US 2023/0085622 A1
(43) Pub. Date: Mar. 23, 2023

(54) PLANT PRODUCTION FACILITY AND PROCESS

(71) Applicants: Andrew J. Moore, Lakewood, CO (US); Stephen L. Simon, Quinter, KS (US)

(72) Inventors: Andrew J. Moore, Lakewood, CO (US); Stephen L. Simon, Quinter, KS (US)

(21) Appl. No.: 17/802,691

(22) PCT Filed: Feb. 26, 2021
(86) PCT No.: PCT/US2021/019921

§ 371 Date: Aug. 26, 2022

Related U.S. Application Data
(60) Provisional application No. 62/982,181, filed on Feb. 27, 2020.

(51) Int. Cl. A01G 9/28; A01G 9/24

(52) U.S. Cl. CPC A01G 9/28; A01G 9/245

(57) ABSTRACT

Described herein are methods of producing plant products and plant production facilities equipped to produce the same on a large-scale. The methods and facilities provide for sprouting directly on a solid growing surface with embedded temperature control, which maximizes independent control of each batch of sprouts or plant products. The embedded temperature control system generally comprises one or more heat transfer conduits for flowing a heat transfer fluid therethrough. A seed spreader device may be used to deposit a bed of plant seeds at a substantially uniform height across the growing surfaces. Advantageously, the simplified design is more cost-effective and can be easily understood, used, and repaired by the average farmer or livestock operator.

### CROSS-REFERENCE TO RELATED APPLICATIONS

The present application claims the priority benefit of U.S. Provisional Patent Application Ser. No. 62/982,181, filed Feb. 27, 2020, entitled CEREAL GRAIN SPROUTING FACILITY AND PROCESS, incorporated by reference in its entirety herein.

### BACKGROUND OF THE INVENTION

### Field of the Invention

The present invention is generally directed to facilities and processes for the large-scale production of plant products.

### Description of Related Art

Sprouted barley grass, also known as sprouts or fodder, is a highly nutritious and highly digestible livestock feed. Many feed rations for various animals are able to substitute timothy grass or alfalfa hay with sprouted barley grass at a one-for-one weight ratio. Fodder systems all operate and produce fodder under the same basic processes in a cycle of four to eight days. Specifically, clean barley seed is loaded into the system, usually on one end of the system into a tray on a shelf with new seed loaded in and pushed along through the system each day. Water is sprayed onto the seed at a set interval and the temperature and humidity within the entire system is maintained at set levels. As the seed takes up water, it will germinate and sprout, producing roots that go down to the bottom of the tray and become tangled together, and grass that grows upward. At the end of the cycle, there are several inches of thick grass held together by a root mat to make a chunk of fresh grass sod or turf. Barley is usually the seed of choice due to nutritional benefits, and it tends to behave the best in fodder systems.

Many companies have developed commercial systems to produce sprouted barley grass from barley seed over the past decade or so, but these systems are either small and highly labor-intensive or large and automated with robotics that may be difficult and expensive to repair should problems occur. Large, automated robotic systems also come at a capital cost and risk that is difficult for an average livestock operation to justify given the unknowns of ongoing repair costs, unfamiliarity with computerized systems, and the relative unfamiliarity that the North American livestock industry as a whole has with sprouted barley grass.

As a result, there is a need for a facility and process to produce large quantities of sprouted grass from cereal grain, as well as other plant products, at a lower capital cost of construction and with low use of labor to operate the system while keeping the technology and mechanics simple and minimizing computerization to make it more accessible and user friendly to the average livestock operator.

### SUMMARY OF THE INVENTION

The present invention is broadly concerned with methods of producing plant products and plant production facilities equipped to produce the same on a large-scale. Embodiments of the present invention provide a number of key advantages over existing plant production systems and facilities, and particularly cereal grain and barley fodder production systems. Notably, the present invention provides sprouting and plant growth directly on a solid growing surface with embedded temperature control, which maximizes independent control of each batch of sprouts or plant products. Advantageously, this method does not use racks or trays, unlike previous fodder production systems. For example, previous systems treat all the barley or other plant seed under the same growing conditions every day, regardless of time within the growth cycle. The present invention uses a simplified design that can be easily understood, used, and repaired by the average farmer or livestock operator.

In one embodiment, there is provided a method of producing a plant product. The method comprises depositing a bed of plant seeds onto one or more growing surfaces. Each of the growing surfaces comprises one or more heat transfer conduits embedded therein. The method further comprises flowing a heat transfer fluid through the one or more heat transfer conduits to control the temperature of the one or more growing surfaces. The bed of plant seeds is watered, thereby producing the plant product.

In another embodiment, there is provided a method of producing a plant product. The method comprises depositing a bed of plant seeds onto one or more growing surfaces with a seed spreader device. The seed spreader device comprises a hopper and a screed that deposits the bed of plant seeds at a substantially uniform height across each of the one or more growing surfaces.

The bed of plant seeds is watered, thereby producing the plant product.

In another embodiment, there is provided a facility for producing a plant product. The facility comprises one or more growing surfaces enclosed within a building structure. Each of the one or more growing surfaces comprises one or more heat transfer conduits embedded therein and configured to flow a heat transfer fluid therethrough to control the temperature of the one or more growing surfaces. The facility further comprises one or more retractable overhead irrigation systems positioned above the one or more growing surfaces. The facility further comprises a seed spreader device comprising a hopper and a screed configured to deposit a bed of plant seeds at a substantially uniform height across each of the one or more growing surfaces.

### BRIEF DESCRIPTION OF THE DRAWINGS

FIG. 1 is a perspective view of a plant production facility according to one embodiment of the present invention;

FIG. 2 is a perspective view of a plant production facility showing an embedded temperature control system according to one embodiment of the present invention;

FIG. 3 is a schematic overhead view of a plant production facility comprising a plurality of growing bays according to one embodiment of the present invention;

FIG. 4 is a perspective view of a plant production facility showing an overhead irrigation system according to one embodiment of the present invention;

FIG. 5 is a perspective view of a plant production facility showing a retracted overhead irrigation system according to one embodiment of the present invention;

FIG. 6 is a cross-sectional view of a growing surface and seed bed taken across line 6-6 of FIG. 1;

FIG. 7 is a perspective view of a seed spreader device according to one embodiment of the present invention;

FIG. 8 is a side view of the seed spreader device of FIG. 7;

FIG. 9 is a perspective view of a plant production facility showing the seed spreader device of FIG. 7 depositing a seed bed onto a growing according to one embodiment of the present invention;

FIG. 10 is a perspective view of a seed spreader device according to one embodiment of the present invention;

FIG. 11 is a photograph showing a bed of barley seeds deposited onto a growing surface of a plant production facility according to one embodiment of the present invention; and

FIG. 12 is a photograph showing a barley grass product (fodder) before harvesting according to one embodiment of the present invention.

### DETAILED DESCRIPTION OF THE PREFERRED EMBODIMENT

Described herein is an improvement on traditional processes for producing plant products, such as sprouted cereal grain grasses (e.g., barley fodder), as well as other plant products. Embodiments of the present invention are generally directed to methods and facilities for the large-scale production of such plant products.

Plant production facilities, and their associated components, according to embodiments of the present invention are described herein. The plant production facilities generally comprise one or more growing surfaces, which may be enclosed within a building structure. The one or more growing surfaces generally comprise an embedded (i.e., in-floor) surface temperature control system. In certain embodiments, the plant production facilities may further comprise a seed spreader device for depositing a bed of plant seeds onto the one of more growing surfaces. In certain embodiments, the plant production facilities may also comprise one or more irrigation systems for watering the bed of plant seeds, thereby sprouting the seeds and growing the plant products, as described in greater detail below.

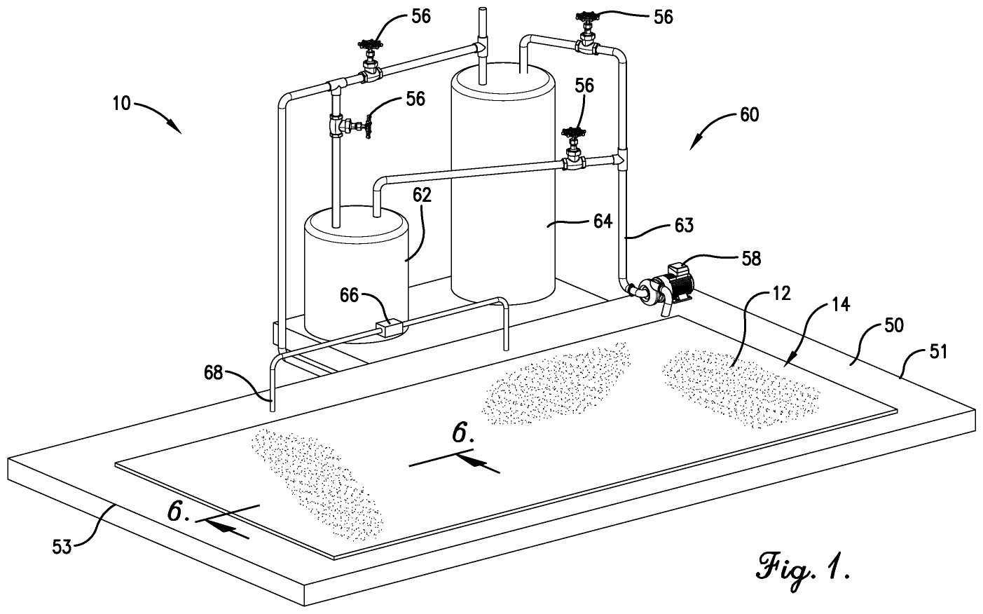

Referring to FIG. 1, an exemplary plant production facility 10 is shown and comprises a growing surface 50 and surface temperature control system 60. Growing surface 50 comprises a substantially flat and solid surface, upon which a bed 14 of plant seeds 12 may be deposited and grown. Growing surface 50 may be made of any suitable building material. However, the selected building material will preferably have thermal conductivity properties such that sufficient heat transfer can occur between the embedded surface temperature control system and the seed bed 14 (or roots of growing plants) deposited on growing surface 50. In certain embodiments, growing surface 50 comprises a material selected from the group consisting of concrete, ceramic, clays, gypsum, slate, stone, and mixtures thereof. In certain preferred embodiments, growing surface 50 comprises concrete. In certain embodiments, growing surface 50 may further comprise a topcoat sealant, which may comprise epoxy, acrylics, or the like. The topcoat sealant can provide for a smoother, more uniform surface, which advantageously allows easier depositing of a uniform seed bed and/or easier cleaning of the growing surface.

While FIG. 1 shows growing surface 50 as a raised platform, it should be understood that growing surface 50 may be continuous with the floor of the plant production facility 10. For example, in certain preferred embodiments, plant production facility 10 may be constructed such that the surface temperature control system is embedded into the floor of plant production facility 10, such that the floor constitutes growing surface 50.

In certain same or other embodiments, growing surface 50 may be constructed so as to provide a slope from a first side 51 of growing surface 50 to an opposing second side 53 of growing surface 50 that is lower in elevation than the first side 51. Such construction advantageously allows excess water to flow toward a drain within plant production facility 10. In certain embodiments, first side 51 has an elevation that is about 1 inch to about 24 inches, about 3 inches to about 18 inches, or about 6 inches to about 12 inches higher than the elevation of second side 53. The slope may also be characterized by the ratio of the difference in elevation between the opposing sides of the growing surface (Δh) to the length of the growing surface (l). In certain embodiments, the ratio Δh:l of the growing surface is about 1:10 to about 1:100, about 1:20 to about 1:75, or about 1:25 to about 1:50. In certain embodiments, the ratio Δh:l of the growing surface is about 1:30. In certain same or other embodiments, the slope has an angle of about 0.1° to about 10°, about 0.5° to about 5°, or about 1° to about 2°.

The growing surface(s) may be any suitable size for the particular plant product or production quantity desired. However, in certain embodiments, the growing surface(s) each have an area of about 50 ft² to about 50,000 ft², preferably about 100 ft² to about 10,000 ft², and more preferably about 500 ft² to about 5,000 ft². Advantageously, the one or more growing surface(s) may be constructed without sidewalls, such that the plant seeds are not restrained from expansion during growth. Advantageously, unlike prior rack or tray designs, embodiments of the present invention do not require such side walls to maintain a substantially uniform height of the bed of plant seeds deposited on the growing surface(s).

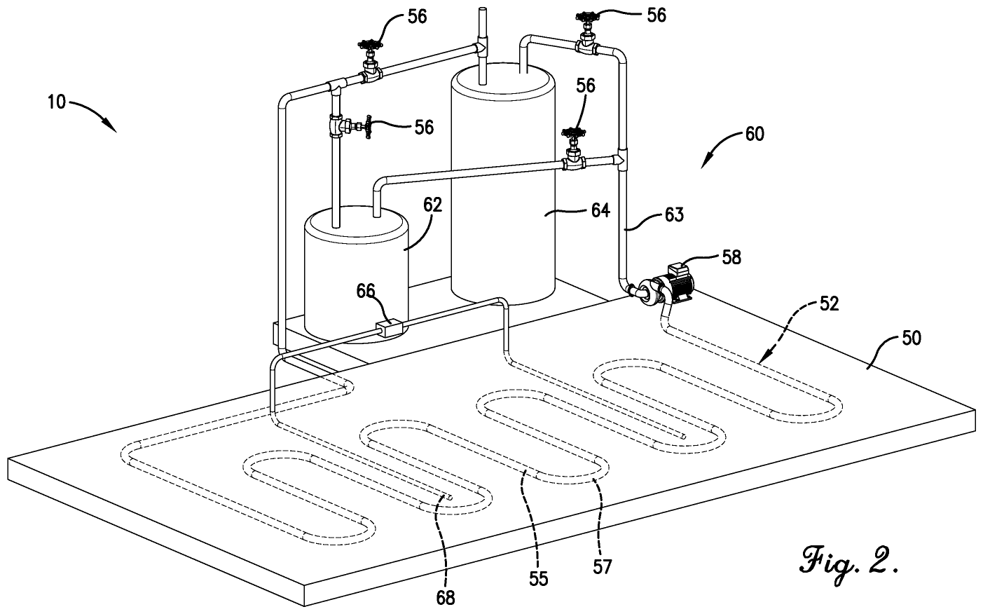

Surface temperature control system 60 is generally configured to effectively control the temperature of growing surface 50, thereby also controlling the temperature of the plant seeds 12 deposited on growing surface 50 and/or plant roots growing on surface 50. Surface temperature control system 60 generally comprises one or more heat transfer conduits embedded within growing surface 50. For example, referring to FIG. 2, a heat transfer conduit 52 is shown embedded within growing surface 50. As used herein, the term “embedded” refers to the heat transfer conduit(s) being securely affixed within, or secured below, the growing surface. For example, the heat transfer conduit(s) may be embedded by flowing a viscous precursor material (e.g., wet concrete) over the heat transfer conduit(s) curing the material, thereby providing a solid growing surface having the heat transfer conduits affixed therein. Alternatively, the heat transfer conduit(s) may be embedded by fastening (e.g., hooks, latches, etc.) or otherwise securing the heat transfer conduit(s) to an underside surface of the growing surface, for example when the growing surface comprises slate, stone, or the like. It should be understood that heat transfer conduits may be embedded within growing surfaces in various other ways within the scope of the present invention, so long as heat transfer conduit(s) are securely affixed within, or secured below, the growing surface(s).

The heat transfer conduit(s) are generally configured to flow a heat transfer fluid therethrough, thereby controlling (i.e., raising, lowering, maintaining) the temperature of the growing surfaces and the plant seeds and/or plant roots growing thereon. The heat transfer fluid may be any suitable fluid material capable of providing the desired heating or cooling of the growing surface. In certain embodiments, the heat transfer fluid comprises a fluid selected from the group consisting of water, anti-freeze, natural oils, synthetic oils, hydrocarbons, silicone-based fluids, air, nitrogen, argon, helium, hydrogen, and mixtures thereof. In certain preferred embodiments, the heat transfer fluid comprises (consists of, or consists essentially of) water.

Referring again to FIG. 2, in certain embodiments, surface temperature control system 60 may further comprise a fluid heater 64 (e.g., a water heater) and/or a fluid cooler 62 (e.g., a water chiller) to maintain the appropriate temperature of growing surface 50. Other single boiler or multiple boiler systems may also be used. Fluid heater 64 and/or a fluid cooler 62 may be connected to the embedded heat transfer conduits 52 using one or more additional pipes, hoses, or other conduits 63 configured to direct the heat transfer fluid from fluid heater 64 and/or fluid cooler 62 through embedded heat transfer conduit 52. In certain embodiments, geothermal system (not shown) may also be utilized, for example, by drilling a hole into the ground, running pipe into the hole, and flowing the heat transfer fluid through the geothermal piping and heat transfer conduit 52.

Surface temperature control system 60 may further comprise various other components so as to provide manual and/or automated temperature control. For example, in certain embodiments, surface temperature control system 60 may further comprise manual or automated valves 56 that can be partially or completely opened or closed to achieve the desired temperature of growing surface 50. Moreover, valves 56 can be adjusted to achieve different temperatures during different growing periods, which can depend on factors such as plant type, air temperatures, and the particular day in the growth cycle. One or more pumps 58 may also be used to achieve the desired flow direction and flow dynamics of heat transfer fluid through heat transfer conduit 52.

The one or more heat transfer conduit(s) and any other pipes, hoses, or other conduits used in the surface temperature control system may be made of any suitable material for containing the heat transfer fluid flowing therethrough. Such materials may include, for example, various polymers or plastics and/or metal-based materials. The heat transfer conduit(s) preferably comprise a material having relatively high thermal integrity, flexibility, and structural strength properties, including abrasion and corrosion resistance, as well as high thermal conductivity. In certain embodiments, the heat transfer conduit(s) comprise a material selected from the group consisting of cross-linked polyethylene (PEX), stainless steel (e.g., corrugated stainless steel), polypropylene (PP), polybutylene (PB), polyvinyl chloride (PVC), metal-plastic composites, and mixtures thereof. The heat transfer conduit(s) may generally comprise a single inner diameter, or this inner diameter may be varied. In certain embodiments, the heat transfer conduit(s) have an inner diameter of about ¼ inches to about 4 inches, about ½ inches to about 3 inches, about¾ inches to about 2 inches, or about 1 inch to about 1½ inches.

As best shown in FIG. 2, in certain embodiments, heat transfer conduit 52 may be embedded in growing surface 50 in a winding pattern, passing back and forth to provide temperature control throughout growing surface 50. When embedded in this pattern, heat transfer conduit 52 will generally comprise a plurality of passes 55 spanning entirely (or almost entirely) across growing surface 50 and being connected by U-shaped portions 57. The number of passes and spacing between passes can be selected so as to achieve the desired amount of temperature uniformity across growing surface 50, and will depend on factors such as the size of growing surface 50, the type of plant product being grown, and the typical air temperature of the growing environment. In certain embodiments, the spacing between passes is about 2 inches to about 24 inches, preferably about 4 inches to about 16 inches, and more preferably about 6 inches to about 10 inches.

To monitor the temperature of growing surface 50, in certain embodiments, one or more temperature probes or sensors 68 may also be embedded within, or secured to the top of, growing surface 50. Temperature sensor 68 may be coupled (wired or wireless) with a display 66 and/or automated control system (not shown) that can adjust the flow of heat transfer fluid through conduit 52 to achieve the desired set point temperature of surface 50. As described in greater detail below, the temperature settings through the growth cycle can be customizable and variable depending on factors such as the weather and plant type.

It should be understood that, while flowing heat transfer fluid through the heat transfer conduit(s) to control the temperature of the growing surface(s) may generally be referred to as “radiant heat” or “radiant temperature control,” the heat transfer conduit(s) are used to directly heat or cool the growing surface(s). That is, the heat transfer conduit(s) are not being used to radiantly control air temperatures, but rather, to control the temperature of the growing surface(s) and thereby also the temperature of the plant seeds and/or growing plant roots deposited thereon. Thus, as described herein, this method may more accurately be referred to as “conductive temperature control.”

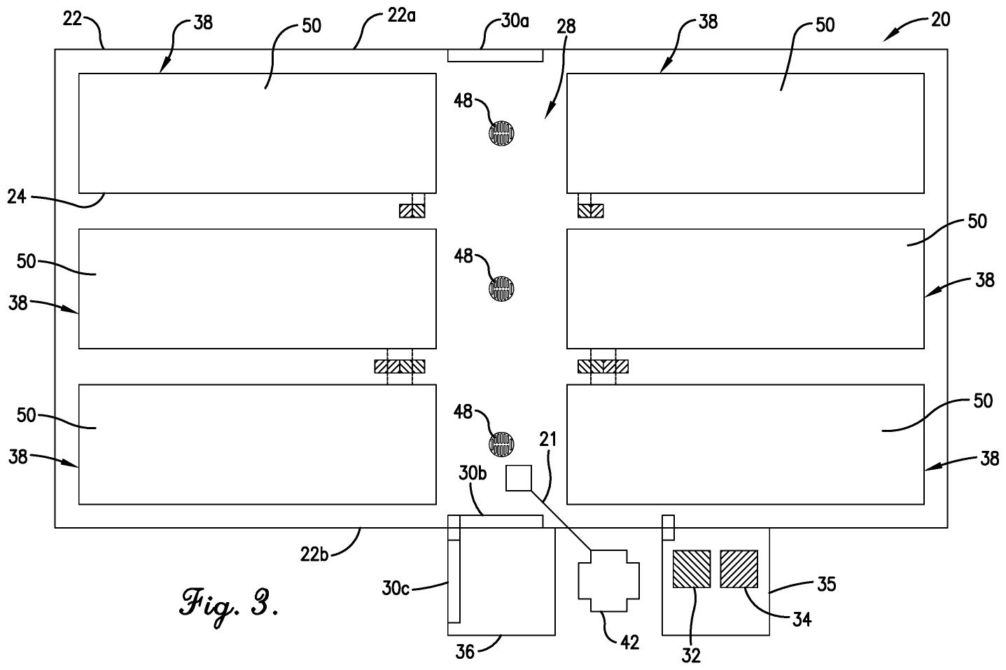

Referring now to FIG. 3 in certain embodiments, the plant production facility comprises a building structure 20, having one or more growing surfaces 50 are enclosed therein. Building structure 20 may comprise a plurality of exterior walls 22, a plurality of interior barriers 24, one or more alleys 28 between growing surfaces 50, and/or a ceiling (not shown). Drains 48 may be included between growing surfaces 50 to remove excess water that flows from growing surfaces 50. The plurality of exterior walls 22 may be made of, for example, steel, concrete, or rock, but any suitable building material may be used.

In certain embodiments, the building structure 20 is at least about 10 feet, at least about 12 feet, or at least about 15 feet in height. In certain embodiments, the building structure 20 is about 10 feet to about 30 feet, about 12 feet to about 20 feet, or about 15 feet to about 20 feet in height. In certain embodiments, the building structure 20 is about 100 to about 500 feet, about 150 feet to about 400 feet, or about 200 feet to about 300 feet in length. In certain embodiments, the building structure 20 is about 50 feet to about 200 feet, about 60 feet to about 150 feet, or about 70 feet to about 100 feet in width. Advantageously, the size of the growing surface upon which the plant seed is spread, and by extension the size of the building structure, can be adjusted to whatever target harvest one wishes to produce. To allow for extra space around each growing surface 50 and space to maneuver through the alley 28, in certain preferred embodiments, building structure 20 may be at least about 150 feet by 80 feet (length by width).

In certain embodiments, building structure 20 further comprises one or more doors, and preferably retractable overhead doors, which can be disposed within exterior walls 22. In certain preferred embodiments, a first overhead door 30a can be positioned, for example, in the center of one exterior wall 22a of the building structure 20, and a second overhead door 30b can be positioned in the center of another exterior wall 22b on the opposite side of the first overhead door 30a.

In certain embodiments, the plant production facility further comprises a grain bin 42. To bring the plant seed into building structure 20 and deposit the seed onto the growing surfaces 50, the plant seed can be transported into the building structure 20 from the grain bin 42 installed near and/or adjacent to the building structure 20 using auger 21 (e.g., flex auger or other augers). Other additional or alternative conveyance devices and systems may also be used, including, but not limited to, a drag chain conveyor or pneumatic transfer system. In certain embodiments, the plant seed can then be loaded into a seed spreader device from auger 21.

In certain embodiments, building structure 20 further comprises one or more climate control system(s) comprising one or more heating, ventilation, dehumidifiers, and/or air conditioning (HVAC) systems to sufficiently control humidity and to sufficiently heat or cool the building structure 20 as needed. The climate control system may comprise, for example, heating system 32 (e.g., a furnace) and/or cooling system 34 (e.g., air conditioner), which may be at least partially housed in utility room 35 within or adjacent building structure 20. Although other climate control systems may be used, regardless the system, heat duty would likely need to be calculated for building structure 20 depending on the production capacity. Pumps and HVAC sizing will generally depend on the size of growing bay 38. Insulation may also be used to facilitate temperature control of the building structure 20. Any suitable insulation material may be used. However, in certain embodiments, insulation that may promote mold growth at certain temperature and humidity conditions should be avoided. In certain such embodiments, for example, unsealed spray foam insulation should be avoided. In certain preferred embodiments, vapor barrier insulation can be installed on any of the exterior walls 22, interior barriers 24, or ceiling. Solar panels may also be installed on the building structure 20 to produce electricity and reduce heat input from the sun.

In certain embodiments, the plant production facility further comprises harvest bay 36 within or adjacent to building structure 20. In certain embodiments, harvest bay 36 further comprises an interior door and an exterior door. As shown in FIG. 3, the interior door may be second overhead door 30b, and the exterior door may be a third overhead door 30c.

As best shown in FIG. 3, in certain embodiments, building structure 20 comprises a plurality of growing bays 38, each comprising a growing surface 50. In certain embodiments, the growing bays 38 are separated from each other and/or alley 28 by one or more barriers 24, such as interior walls, tarps, awnings, or any suitable material that can act as a barrier between each growing surface 50. This advantageously isolates each growing surface 50, allowing for better independent control of growing conditions within each bay 38. In certain embodiments, the plurality of growing bays 38 may be partially or entirely defined by solid walls constructed between each growing surface, or entirely separate buildings may be built. In certain embodiments, each growing bay 38 may further comprise a separate climate control system, preferably an HVAC system, humidifier, and/or dehumidifier, configured to independently control the air temperature and/or humidity within each bay 38.

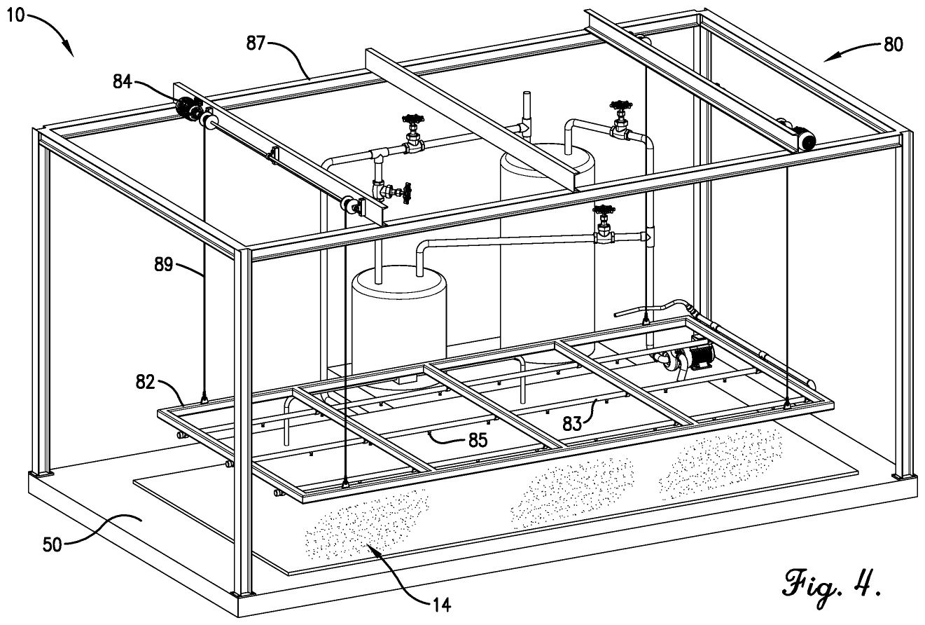

In certain embodiments, plant production facility 10 further comprises one or more irrigation systems configured to supply water to the plant seeds and/or the plants growing on the growing surfaces(s). As best shown in FIG. 4, in certain embodiments, the one or more irrigation systems may comprise an overhead irrigation system 80 positioned above growing surface 50. In certain embodiments, overhead irrigation system 80 may comprise a rack 82 comprising water conduits 83 and sprinklers or sprayers 85 coupled to a water source (not shown) operable to supply water to sprinklers 85. Thus, after the seed bed 14 is deposited on growing surface 50, the seed bed and/or growing plants can be watered from above via sprinklers 85 by overhead irrigation system 80.

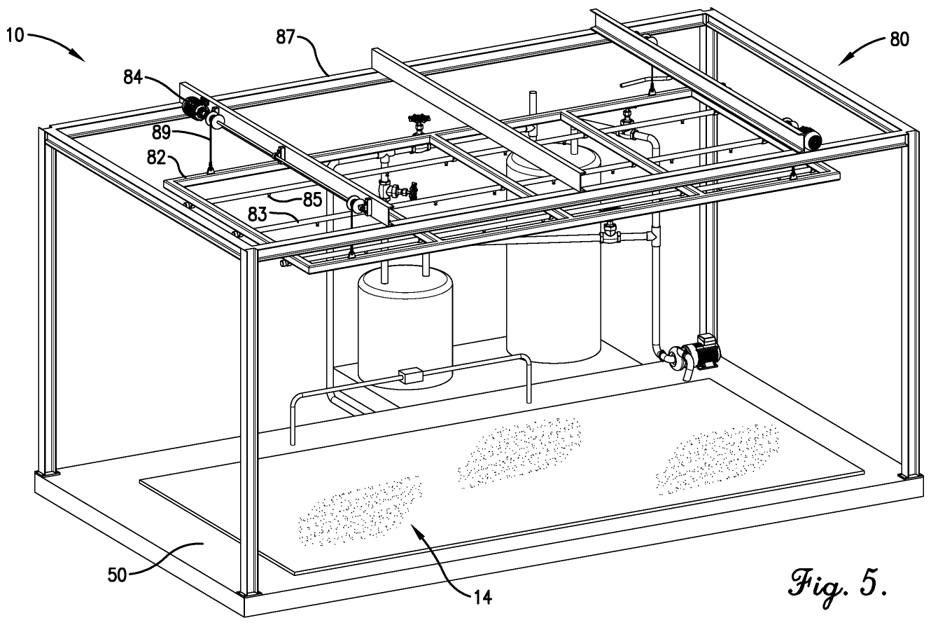

In certain embodiments, overhead irrigation system 80 is a retractable overhead irrigation system, wherein rack 82 is suspended from a support structure 87 and/or other portion of building structure 20 by cables 89. As shown in FIG. 4, while water is being supplied, for example during the growing period of the seeds into the plant product, rack 82 can be positioned about 1 foot to about 20 feet, preferably about 2 feet to about 5 feet above growing surface 50. As shown in FIG. 5, when it is time to harvest the plant product, clean growing surface 50, and/or deposit new plant seed on growing surface 50, or when repairs need to be made, rack 82 can be retracted (i.e., raised), for example, via one or more winches 84. In certain embodiments, overhead irrigation system 80 can be automated and the timing of watering can be adjusted depending on the day in the growth cycle. Advantageously, in certain embodiments, each growing bay 38 within building structure 20 may have its own dedicated overhead irrigation system 80.

In certain same or other embodiments, the one or more irrigation systems comprises a water distribution system configured to supply water from one or more sides of growing surface 50. As noted above, growing surface 50 may be sloped. Thus, in certain such embodiments, when water from the distribution system is applied to growing surface 50, the water flows from the first side 51 of growing surface 50 toward the opposing second side 53 of surface 50, thereby providing water to the plant seed and/or plants growing thereon.

Embodiments of the present invention are also directed to methods of producing plant products. Methods in accordance with certain embodiments of the present invention generally comprise depositing plant seed onto one or more growing surfaces to form a plant seed bed, and flowing heat transfer fluid through one or more heat transfer conduits to control (i.e., raise, lower, or maintain) the temperature of the one or more growing surfaces, thereby controlling (i.e., raising, lowering, or maintaining) the temperature of seeds and/or roots of plants on the growing surfaces.

As used herein, the term “seed” refers to the embryonic form of a plant that is capable of sprouting and growing into a plant product. As used herein, the term “plant product” may refer to any harvestable plant or portion of a plant formed after germination of the seed. This may include plant sprouts, juvenile plants, and/or mature (adult) plants. In certain preferred embodiments, the plant product is a harvestable plant, including, but not limited to, a sprouted cereal grain grass (e.g., barley fodder). In certain embodiments, the deposited plant seed comprises a plant seed bed (see FIG. 1) comprising a quantity of plant seeds selected from the group consisting of wheat, barley, millet, oats, grain rye, ryegrass, corn, sunflower seed, sorghum, and mixtures thereof. In certain preferred embodiments, the quantity of plant seeds comprises cereal grains, such as barley seeds. However, in certain same or other embodiments, the plant seeds may comprise seeds for growing other plants, including, but not limited to, microgreens and food crops.

In certain embodiments, the plant seeds may be mixed with soil, fertilizer, and or additives and are deposited onto the growing surface(s) as a growing mixture. However, in certain embodiments, no soil, fertilizer, or additives are included, and thus the deposited plant seed bed consists (or consists essentially of) plant seeds.

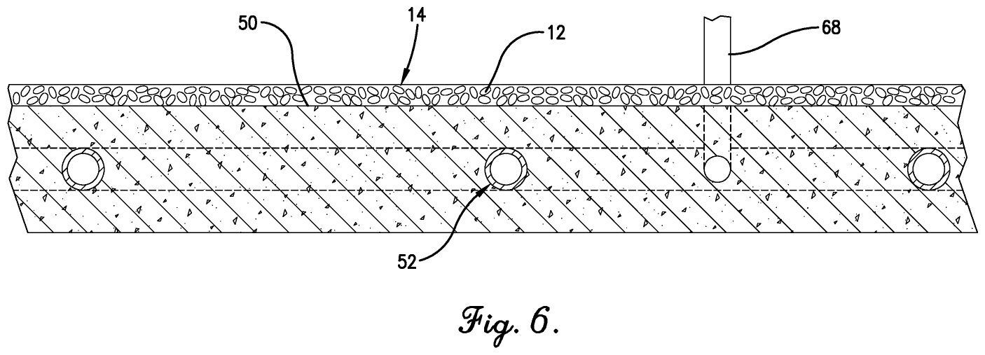

As described above, the one or more growing surface(s) generally comprises a solid, substantially flat surface, which allows for simplified depositing of the plant seed. As best shown in FIG. 6, plant seed 12 may be deposited such that plant seed bed 14 has substantially uniform height (or thickness) across growing surface 50. In certain embodiments, the bed of plant seeds 14 has an average height of about 0.25 inches to about 1 inch, preferably about 0.3 inches to about 0.75 inches, and more preferably about 0.35 to about 0.5 inches. In certain preferred embodiments, the average height of the bed of plant seeds 14 can be about 0.38 inches.

As described above, the plant production facility may comprise two or more growing surfaces, for example in two or more adjacent growing bays 38 (FIG. 3). In certain embodiments, a first bed of plant seeds may be deposited onto a first growing surface, and a second bed of plant seeds may be deposited onto a second growing surface adjacent to the first growing surface. The second bed of plant seeds may be deposited about 12 hours to about 5 days, preferably about 1 day to about 2 days, after depositing the first bed of plant seeds. As described above, a barrier (e.g., wall, tarp, etc.) can be installed between each growing surface, allowing for better isolation of each growing surface and for independent temperature control.

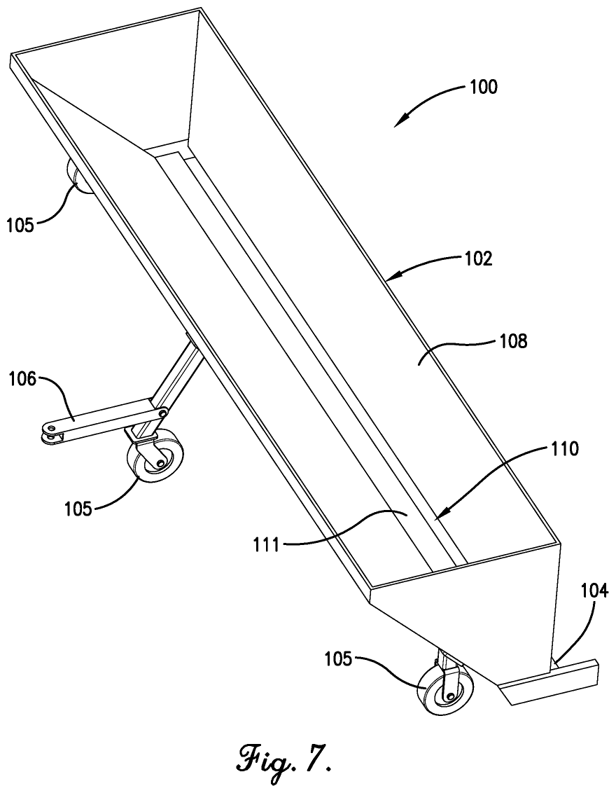

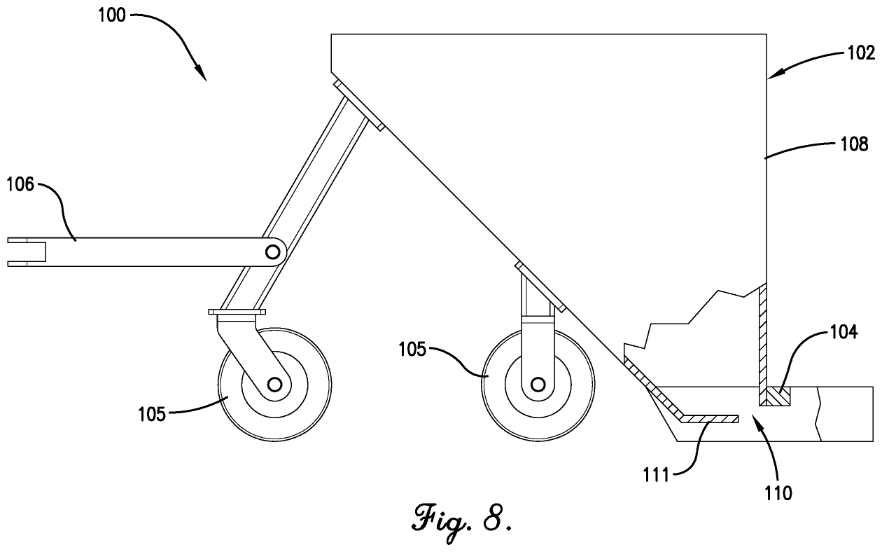

In certain embodiments, plant seeds can be deposited onto one or more growing surfaces using a seed spreader device. One exemplary seed spreader device 100 is shown in FIG. 7 and FIG. 8. As shown, in certain embodiments, seed spreader device 100 generally comprises hopper 102 and screed 104. Hopper 102 comprises tank 108 configured to hold a quantity of plant seeds to be deposited and bottom outlet 110 through which seeds pass during depositing. In certain embodiments, the plant seed can be loaded directly into tank 108 of hopper 102. The lower outlet 110 allows seed spreader device 100 to open to the growing surface(s) and provides a means to close device 100 to prevent the plant seed from flowing out of hopper 104. For example, in certain embodiments, a slat 111 below bottom outlet 110 of the hopper that can be opened and closed to start and stop the flow of seed. Screed 104 is configured to flatten the deposited plant seed into a bed having a substantially uniform height. Screed 104 can be adjusted to achieve the desired height of the plant bed. The seed spreader may be made of any suitable material, such as wood, metal, plastics, and the like.

In certain embodiments, seed spreader device 100 comprises one or more wheels 105 and/or tow hitch 106 to allow for easier movement of the device across the growing surface. In certain embodiments, seed spreader device 100 can be pulled by an ATV, small tractor or other vehicle, an airplane tug, or it could be built as an attachment to a skid steer or telehandler with a hydraulic connection to open and close the slat.

Additionally, in certain embodiments, hopper 102 can be made water-tight and/or function as a pre-soak tank. Advantageously, the combination of pre-soaking the seed (particularly cereal grain seed) and the temperature control of the growing surface(s) can result in reduced growth time required on the growing surface to about 3 to about 5 days. Furthermore, the plant seed can commonly become extremely difficult to spread once the seed becomes wet. However, the seed spreader device 100 in accordance with certain embodiments of the present invention can advantageously deposit wet (e.g., pre-soaked) seed, which can be particularly difficult to deposit onto a growing surface using existing technologies.

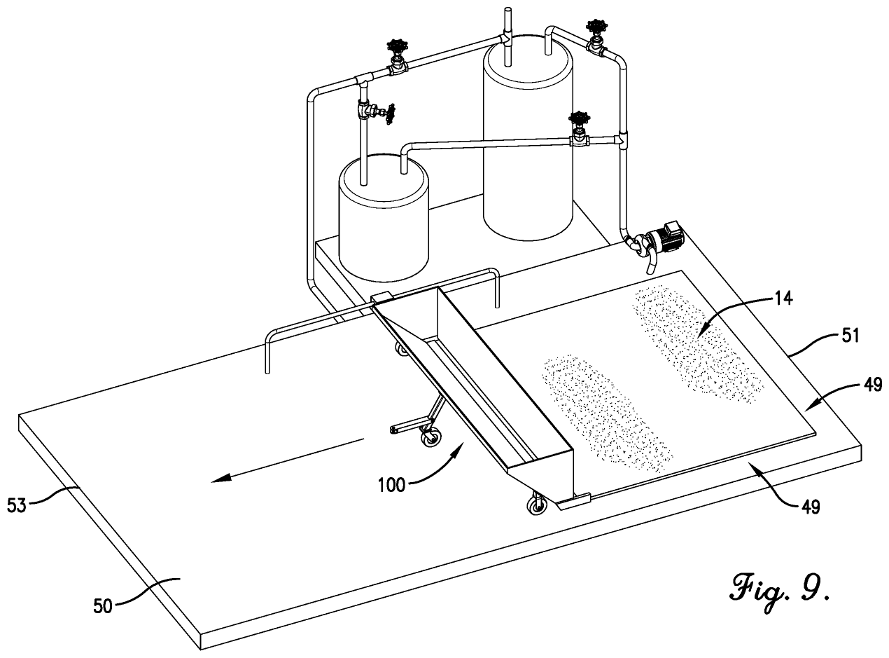

In certain embodiments, as best shown in FIG. 9, to deposit the plant seed, seed spreader device 100 may be passed across growing surface 5, for example, from a first side 51 to a second side 53 (or vice versa). In certain embodiments the plant seeds can be deposited from lower outlet 110 at a height of less than about 6 inches above growing surface 50. In certain embodiments, the plant seeds can be deposited on growing surface 50 so that a margin 49 of growing surface 50 is left uncovered. In other words, the plant seeds may be deposited in such a way that they do not contact, and/or are not restrained by, any sidewalls, yet still maintain their desired height substantially across seed bed 14.

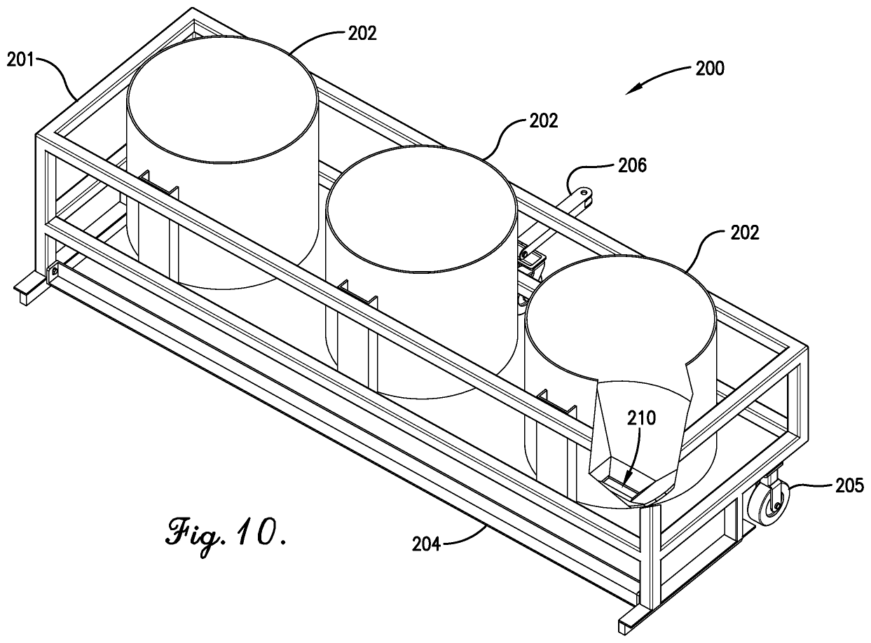

Another exemplary seed spreader device 200 is shown in FIG. 10. As shown, in certain embodiments, seed spreader device 200 generally comprises a frame 201 holding a plurality of hoppers 202 and a screed 204. As above, each hopper 202 generally comprises a tank configured to hold plant seeds to be deposited from a bottom outlet 210. Again, in certain embodiments, a slat may be positioned below bottom outlet that can be opened and closed to start and stop the flow of seed. Screed 204 is configured to flatten the deposited plant seed into a bed having a substantially uniform height. Screed 204 can be adjusted to achieve the desired height of the seed bed. Wheels 205 and a tow hitch 206 may be included to provide for easier movement of seed spreader device 200.

To grow the plant product, water is applied to the deposited plant seeds and is continued to be applied when the seeds sprout and grow. In certain embodiments, nutrients and/or other additives may be mixed with the water, which can be absorbed to provide nutrition to the plant product and/or to the livestock consuming the plant product. For example, in certain embodiments, gibberellic acid can be mixed into the water to stimulate germination and accelerate early growth in the plant products. In certain embodiments, water can be applied to the deposited seeds and/or growing plants on the growing surfaces from one or more irrigation systems, such as an overhead irrigation system as described herein, or other water distribution system. In certain same or other embodiments, water can be applied from one or more sides of the growing surface(s), with the water gradually wetting the entirety of the seed bed. As described above, the one or more growing surfaces may have a slight slope or angle, thereby allowing excess water to flow to one or more drains within the plant production facility. In certain embodiments, the water is applied to the seeds and/or growing plants at a temperature of about 55° F. to about 80° F.

Watering rates may be varied as necessary or desired, depending on factors known in the art, such as the type of plant products being grown, plant seed bed thickness, and growing conditions. Generally, watering rates will be greater initially to soak the plant seeds and begin germination, with the watering rate tapering off as the plant products grow. In certain embodiments, water is applied to the seed bed and/or growing plants at a rate of about 0.01 to about 0.5 gallons per square foot per hour, preferably about 0.02 to about 0.2 gallons per square foot per hour, and more preferably about 0.03 to about 0.15 gallons per square foot per hour. In certain embodiments, during about 1 hour to about 24 hours after depositing, seed bed is initially watered at a rate of about 0.1 to about 0.5 gallons per square foot per hour to soak the seeds, and the seeds and/or growing plants are watered at a rate of about 0.01 to about 0.3 gallons per square foot per hour thereafter until harvest, which can be about 4 to about 6 days after depositing. In certain embodiments, seed bed and/or growing plants may also be flooded intermittently, which is, for example, a full (or almost full) submersion.

In certain same or other embodiments, the seeds may be pre-soaked before depositing on the growing surface(s). To pre-soak the plant seeds, the plant seeds can be submerged in water inside a tank for multiple hours. In certain embodiments, the water temperature of the pre-soak tank can be maintained at a temperature of about 50° F. to about 100° F., preferably about 65° F. to about 80° F. In certain embodiments, the plant seed may soak for about 1 to about 24 hours, preferably about 4 to about 12 hours. The water can then be drained from the tank, and the plant seed (or sprouted seed) can then be deposited on the growing surface(s). After draining, the seed may be immediately deposited on the growing surface(s), for example using a seed spreader device as described herein, or the seed may be air rested for 2 to 24 hours, preferably 4 to 12 hours, and then soaked again. In certain embodiments, air can be continuously pumped into the pre-soak tank to keep the water oxygenated. However, in certain embodiments, such intermittent flooding and/or pre-soak is unnecessary and avoided in the systems and processes described herein.

After the plant seed is deposited onto the growing surface(s), the temperature of the growing surface(s) can be set, maintained, and/or adjusted using the surface temperature control system according to embodiments of the present invention described herein. In certain embodiments, a heat transfer fluid can be flowed through the one or more heat transfer conduit(s) to control (i.e., raise, lower, or maintain) the temperature of the one or more growing surface(s). As noted above, the materials of the heat transfer fluid, one or more conduits, and one or more growing surfaces are selected to allow for effective conductive heat transfer between the heat transfer fluid and the growing surface(s) (and thereby by seeds and/or roots of plants growing thereon). In certain embodiments, the one or more growing surface(s) are maintained at an average temperature of about 55° F. to about 80° F. after the plant seed has been deposited on the growing surface(s) and until harvesting of the pant product. In certain preferred embodiments, from 0 hours to about 72 hours after the plant seed has been deposited, the heat transfer fluid can be flowed through the one or more heat transfer conduit(s) to maintain the growing surface(s) at an average temperature of about 65° F. to about 80° F. In certain same or other embodiments, from about 72 hours to about 168 hours after the plant seed has been deposited (or until harvest), the heat transfer fluid may be flowed through the one or more heat transfer conduit(s) to maintain the growing surface(s) at an average temperature of about 55° F. to about 70° F.

As noted above, in certain embodiments, the plant production facility may comprise one or more climate control systems. In certain embodiments, the climate control system(s) can be configured to control (e.g., maintain, raise, lower) the air temperature within building structure 20, and particularly in the environment above and/or surrounding the one or more growing surfaces 50. Such climate control, along with appropriate insulation, can be particularly important in large-scale production facilities. For example, mold is much more likely to develop at prolonged temperatures above 70° F., or above 80° F. Advantageously, such climate control system(s), in combination with the surface temperature control system, are capable of maintaining the roots of growing plants cooler during the later days of the cycle, and also drawing away the heat generated by cellular respiration, while keeping the air temperature higher. For example, in certain embodiments, the growing surface(s) (and the roots of the plants growing thereon) can be maintained at an average temperature of about 55° F. to about 70° F., or about 60° F. to about 65° F., while the air temperature above and/or surrounding the growing surface(s) (and the plants growing thereon) can be maintained at an average temperature of about 60° F. to about 80° F., or about 70° F. to about 75° F. In this way, embodiments of the present invention overcome problems with existing fodder systems, which often develop rot, mold, and/or decay in the root mats because of the excess heat generated by cellular respiration that builds up, particularly during the later stages of the growth cycle.

After a desired growing period, the plant product can be harvested using any of a variety of harvesting methods, which may depend on the particular plant product being harvested. In certain embodiments, the plant product can be harvested, for example, with a plastic-rimmed loading bucket on a skid steer or telehandler. In certain embodiments, the plant product is harvested about 3 to about 7, or about 4 to about 6 days after depositing plant seed onto the growing surface. When the plant product is a cereal grain grass (e.g., barley fodder), for example, the plant product may be harvested when the grass has a height of about 2 inches to about 10 inches, about 4 inches to about 8 inches, or about 5 inches to about 7 inches.

In certain embodiments, a frame can be used to form one or more barriers in the deposited seed bed to prevent rootlets from growing together. Thus, the frame may function similar to a cookie cutter to make specifically sized, pre-cut chunks of plant product that can be harvested, e.g., by hand or other means. Various shapes can also be made, such as letters and logos. However, in certain other embodiments, no frame or other barrier is placed on the growing surface to contain the plant seed and/or plants growing on the growing surface.

To simplify and expedite harvest, a harvest bay, such as described above, can be installed adjacent to the building structure so that the harvested plant products can be accessed without interfering with any growing bays. As shown in FIG. 3, in certain embodiments, the harvest bay 36 may share an interior overhead door 30b with the building structure 20 so that the door 30b can be opened to load the harvested plant products into the harvest bay 36. Once the plant product is loaded in the harvest bay 36, the interior overhead door 30b can be closed, and an exterior overhead door 30c in the harvest bay 36 can be opened, so that the plant product may be picked up and mixed according to whatever feed ration is being prepared. Advantageously, this design of harvest bay 36 facilitates efficient and immediate hauling of the plant products, minimizes infiltration of outside air, and conserves air conditioning. Such an “air lock” configuration may advantageously limit conditioned air loss and exterior contaminant infiltration during harvest, which is a major issue with prior commercial fodder systems.

After the plant product is harvested, the growing surface(s) can be cleaned, and new plant seeds may be deposited on the growing surface(s). As noted above, hard epoxy or other sealant on the growing surface can be used to provide a smoother growing surface, which may improve durability and make the surface easier to harvest and clean. To clean the growing surface(s), there are at least three processes contemplated herein, which can be used alone or in combination. First, the growing surface(s) may be manually power washed. Second, another water system, for example separate from the irrigation system(s) described herein, may be installed above each growing bay. This system can apply high pressure and have sprayers pointed at the growing surface(s) at an angle to move any debris toward the end or the side of the growing surface(s). The additional water system may include a plurality of sprayers that can be spaced to maximize their efficiency in spraying off debris. The sprayers can also be programmed in sequence to limit the amount of debris that each sprayer must move. Third, a high-pressure power sprayer system may be installed on a seed spreader device, such as described herein, that will spray as it is pulled across the growing surface. Each of the foregoing systems may include a disinfectant or disinfectant mixture, such as water treated with bleach, to disinfect the growing surface prior to depositing the plant seed. Cleanliness is critical to preventing mold growth throughout the building and within the plant products. For example, cows and sheep appear to have no trouble eating sprouts or grass with a significant amount of mold growth, but horses cannot safely consume any mold.

In a particularly preferred embodiment, the plant seeds comprise a cereal grain seed (e.g., barley), which is deposited and grown on a growing surface having a surface area of about 1,000 ft² to about 10,000 ft². In certain preferred embodiments, the growing surface has a dimension of about 20 feet by 60 feet. Operating on a six-day harvest cycle, for example, six growing surfaces of this size may produce a 10,000 lb harvest of barley sprouts and/or grass each day. Through dimensional and weight measurements, about 6 to 10 lbs, preferably about 7 lbs to about 9 lbs, and more preferably about 8.4 lbs to about 8.5 lbs of barley grass (fodder), can be produced per square foot of barley seed deposited at a thickness of about 0.38 inches. Therefore, in certain preferred embodiments, about 10,000 lbs of sprouts can be produced from an area of just under 1,200 ft².

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following example sets forth a pilot plant for a large-scale plant production system and process in accordance with one embodiment of the present invention. It is to be understood, however, that this example is provided by way of illustration and nothing therein should be taken as a limitation upon the overall scope of the invention. It is also understood that the inventive process is highly adjustable, and the parameters will likely need to be adjusted depending on several factors known in the art, such as the time of year, weather, and type of plant seed used to produce the desired plant product. Additionally, the size of the plant production facility and growing surface(s) can be varied based on plant production needs.

Inside the building structure of the pilot plant production facility, PEX tubing was laid out in 16″ spacing before pouring concrete. The tubing running through each slab was connected to a hot water source and a cold water source. In the pilot system, an electric water heater and a large water chiller was used.

Above each production slab, a wood watering rack was suspended. This rack holds PVC tubing with sprayers to spray the bed of seed from above. The rack is coupled to a winch line so that it can be pulled up out of the way during harvest, for ease of maintenance, and adjusted for sprayer range and performance. Water was sprayed intermittently for time periods of about 10 seconds to about 1 minute every 1-2 hours.

A seed spreader device was used to quickly and efficiently spread seed evenly on the slab. The seed spreader includes a hopper box that is open to the floor. The back side has a gap between the floor and base of the hopper box that allows seed to be spread out behind the box as the box is pulled along the floor. The height of that gap is adjustable. The seed bed height for sprouted grass systems will generally be from 0.25″ to 1″. The thicker the seed bed, the lower the total weight gain from seed to grass through the growing cycle. ⅜″ thickness generally gives 7 lbs of fodder for 1 lb of seed. Thicker beds give lower yields of 6 lbs or 5 lbs per 1 lb of seed.

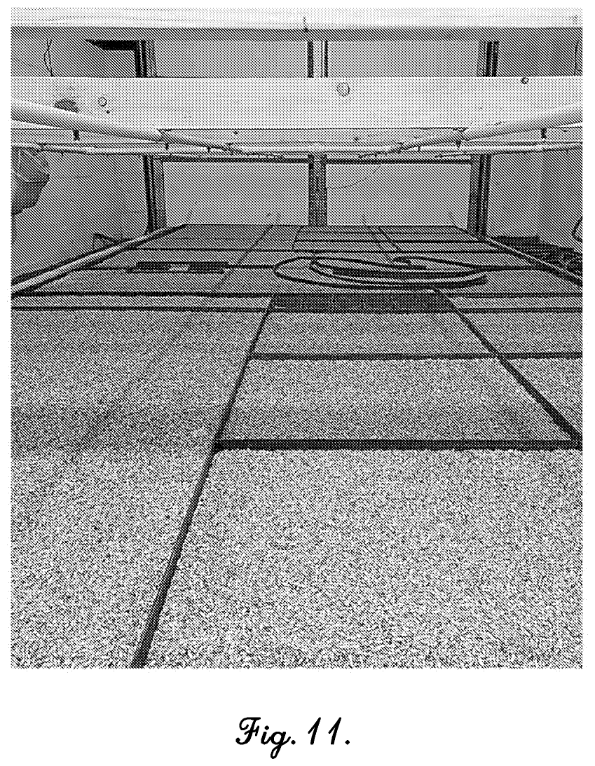

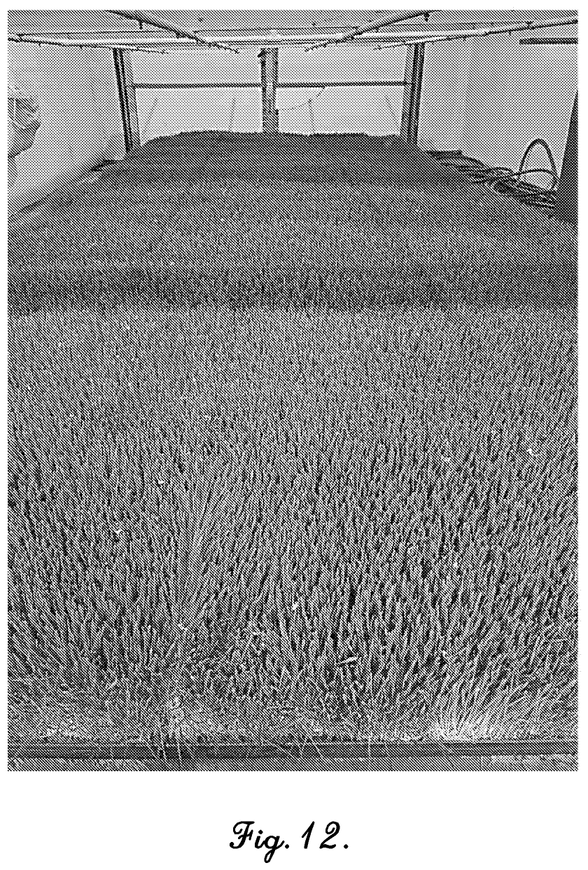

Barley seed was spread and grown using the pilot system described above. In this experiment, a metal frame was used to form a one inch barrier placed in the seed bed to prevent rootlets from growing together. The pilot plant did not have a furnace or climate control system, and thus air temperatures were lower than they should have been for normal sprouting and plant growth as this experiment was conducted during the winter in the midwest. Therefore, it took two days longer than the normal six-day growth cycle. Growth started somewhat uneven, but became more even as cellular respiration heat spread and warmed the seed bed. Progress at days 1 and 8 are shown in FIGS. 11 and 12, respectively.

1. A method of producing a plant product, said method comprising:
depositing a bed of plant seeds onto one or more growing surfaces, each of said growing surfaces comprising one or more heat transfer conduits embedded therein;
flowing a heat transfer fluid through said one or more heat transfer conduits to control the temperature of said one or more growing surfaces; and
watering said bed of plant seeds, thereby producing said plant product.

2. The method of claim 1, wherein said flowing said heat transfer fluid through said one or more heat transfer conduits maintains said one or more growing surfaces at an average temperature of about 55° F. to about 80° F. after said depositing.

3. The method of claim 1, wherein:
(i) from 0 hours to about 72 hours after said depositing, said flowing maintains said one or more growing surfaces at an average temperature of about 65° F. to about 80° F.; and
(ii) from about 72 hours to about 168 hours after said depositing, said flowing maintains said one or more growing surfaces at an average temperature of about 55° F. to about 70° F.

4. The method of claim 1, further comprising maintaining the air temperature above and/or surrounding said one or more growing surfaces at an average temperature of about 60° F. to about 80° F.

5. The method of claim 4, wherein said flowing said heat transfer fluid through said one or more heat transfer conduits maintains said one or more growing surfaces at an average temperature that is lower than the average air temperature above and/or surrounding said one or more growing surfaces.

6. The method of claim 1, wherein said heat transfer fluid comprises a fluid material selected from the group consisting of water, anti-freeze, natural oils, synthetic oils, hydrocarbons, silicone-based fluids, air, nitrogen, argon, helium, hydrogen, and mixtures thereof.

7. The method of claim 1, wherein said bed of plant seeds has a substantially uniform height across each of said one or more growing surfaces.

8. The method of claim 1, wherein said bed of plant seeds has an average height of about 0.25 inches to about 1 inch.

9. The method of claim 1, wherein said watering comprises applying water to said bed of plant seeds from one or more retractable overhead irrigation systems positioned above each of said one or more growing surfaces.

10. The method of claim 1, wherein said watering comprises applying water to said bed of plant seeds at a rate of about 0.01 to about 0.5 gallons per square foot of said bed of plant seeds per hour.

11. The method of claim 1, wherein said bed of plant seeds is deposited onto at least one of said one or more growing surfaces such that said bed of plant seeds does not contact, and/or is not restrained by, any sidewalls.

12. The method of claim 1, wherein said bed of plant seeds comprise a quantity of seeds selected from the group consisting of wheat, barley, millet, oats, grain rye, ryegrass, corn, sunflower seed, sorghum, and mixtures thereof.

13. A method of producing a plant product, said method comprising:
depositing a bed of plant seeds onto one or more growing surfaces with a seed spreader device, said seed spreader device comprising a hopper and a screed that deposits said bed of plant seeds at a substantially uniform height across each of said one or more growing surfaces; and
watering said bed of plant seeds, thereby producing said plant product.

14. The method of claim 13, further comprising pre-soaking plant seeds in water to form a quantity of pre-soaked plant seeds, wherein said bed of plant seeds comprises said pre-soaked plant seeds.

15. The method of claim 13, wherein said bed of plant seeds has substantially uniform height across each of said one or more growing surfaces.

16. The method of claim 13, wherein said bed of plant seeds is deposited from a lower outlet of said hopper at a height of less than about 6 inches above said one or more growing surfaces.

17. The method of claim 13, wherein said depositing comprises passing said seed spreader device from a first end of said growing surface to a second end of said growing surface.

18. The method of claim 13, wherein said depositing comprises depositing a first bed of plant seeds onto a first growing surface, and from about 12 hours to about 5 days after depositing said first bed of plant seeds, depositing a second bed of plant seeds onto a second growing surface adjacent to said first growing surface.

19. A facility for producing a plant product, said facility comprising:
one or more growing surfaces enclosed within a building structure, each of said one or more growing surfaces comprising one or more heat transfer conduits embedded therein and configured to flow a heat transfer fluid therethrough to control the temperature of said one or more growing surfaces;
one or more retractable overhead irrigation systems positioned above said one or more growing surfaces; and
a seed spreader device comprising a hopper and a screed configured to deposit a bed of plant seeds at a substantially uniform height across each of said one or more growing surfaces.

20. The facility of claim 19, wherein said one or more growing surfaces comprises at least a first growing surface and a second growing surface.

21. The facility of claim 20, wherein said first growing surface and said second growing surface are separated by a barrier at least partially defining a first growing bay and a second growing bay.

22. The facility of claim 21, wherein each of said first growing bay and said second growing bay comprise a climate control system configured to independently control the air temperature and/or humidity within each of said first growing bay and said second growing bay

23. The facility of claim 19, wherein said one or more growing surfaces comprises a material selected from the group consisting of concrete, ceramic, clays, gypsum, slate, stone, and mixtures thereof.

24. The facility of claim 19, wherein said one or more growing surfaces comprises a topcoat sealant.
